(19) United States
(12) Patent Application Publication
(10) Pub. No.: US 2024/0070910 A1
(43) Pub. Date: Feb. 29, 2024

(54) PROCESSING METHOD AND PROCESSING DEVICE FOR GENERATING CROSS-SECTIONAL IMAGE FROM THREE-DIMENSIONAL POSITION INFORMATION ACQUIRED BY VISUAL SENSOR

(71) Applicant: Fanuc Corporation, Minamitsuru-gun, Yamanashi (JP)

(72) Inventor: Junichirou Yoshida, Minamitsuru-gun, Yamanashi (JP)

(73) Assignee: Fanuc Corporation, Minamitsuru-gun, Yamanashi (JP)

(21) Appl. No.: 18/272,156

(22) PCT Filed: Jan. 24, 2022
(86) PCT No.: PCT/JP2022/002438

§ 371 Date: Jul. 13, 2023

(30) Foreign Application Priority Data
Jan. 28, 2021 (JP) 2021-012379

(51) Int. Cl. G06T 7/73; B25J 9/16; G06T 7/11

(52) U.S. Cl. CPC G06T 7/74; B25J 9/1697; G06T 7/11; G06T 2200/24; G06T 2207/10012; G06T 2207/20021; G06T 2207/20092

(57) ABSTRACT

A control device according to the present invention comprises a visual sensor and a position information generating unit that generates a distance image of a workpiece. The control device comprises a cutting-plane line setting unit that sets, via an operation performed on the distance image of the workpiece, a cutting-plane line where a surface of the workpiece is cut. The control device comprises a cross-sectional image generating unit that generates a two-dimensional cross-sectional image on the basis of position information, of the surface of the workpiece, that corresponds to the cutting-plane line set by the cutting-plane line setting unit.

### CROSS REFERENCE TO RELATED APPLICATIONS

This is the U.S. National Phase application of PCT/JP2022/002438, filed Jan. 24, 2022, which claims priority to Japanese Patent Application No. 2021-012379, filed Jan. 28, 2021, the disclosures of these applications being incorporated herein by reference in their entireties for all purposes.

### FIELD OF THE INVENTION

The present invention relates to a processing device and a processing method for generating a cross-sectional image based on three-dimensional position information acquired by a vision sensor.

### BACKGROUND OF THE INVENTION

There is known a vision sensor that images an object and detects a three-dimensional position of a surface of the object. Examples of a device that detects a three-dimensional position include a time-of-flight camera that measures time taken for light emitted from a light source to be reflected by a surface of an object and return to a pixel sensor. The time-of-flight camera detects a distance from the camera to the object or a position of the object based on time taken for light to return to the pixel sensor. Also, as a device that detects a three-dimensional position, a stereo camera including two two-dimensional cameras is known. The stereo camera can detect a distance from the stereo camera to an object or a position of the object based on parallax between an image captured by one camera and an image captured by the other camera (e.g., Japanese Unexamined Patent Publication No. 2019-168251A and Japanese Unexamined Patent Publication No. 2006-145352A).

Also, it is known that the number of objects or a distinctive portion of an object is detected based on three-dimensional positions of surfaces of the object(s) acquired based on an output of a vision sensor (e.g., Japanese Unexamined Patent Publication No. 2019-87130A and Japanese Unexamined Patent Publication No. 2016-18459A).

### PATENT LITERATURE

[PTL 1] Japanese Unexamined Patent Publication No. 2019-168251A
[PTL 2] Japanese Unexamined Patent Publication No. JP 2006-145352A
[PTL 3] Japanese Unexamined Patent Publication No. 2019-87130A
[PTL 4] Japanese Unexamined Patent Publication No. 2016-18459A

### SUMMARY OF THE INVENTION

A vision sensor that detects a three-dimensional position of a surface of an object is called a three-dimensional camera. A vision sensor such as a stereo camera can set a large number of three-dimensional points on a surface of an object in an imaging region and measure a distance from the vision sensor to each of the three-dimensional points. Such a vision sensor executes area-scanning for acquiring distance information in the entire imaging region. Even when a position at which an object is placed is not determined, the position of the object can be detected by an area-scan type vision sensor. The area-scan type is characterized in that an arithmetic processing amount is large, because the positions of the three-dimensional points are calculated over the entire imaging region.

On the other hand, as a device that detects a position of a surface of an object, there is known a vision sensor that executes line scanning in which an object is irradiated with a linear laser beam. A line-scan type vision sensor detects positions on a line along the laser beam. Thus, a cross-sectional image of a surface along the laser beam is generated. For the line-scan type vision sensor, it is necessary to place an object at a predetermined position with respect to a position to be irradiated with the laser beam. However, it is characterized in that a protrusion or the like on the surface of the object can be detected with a small arithmetic processing amount.

Area-scan type vision sensors are used in many fields such as a field of machine vision. For example, an area-scan type vision sensor is used for detecting a position of a workpiece in a robot apparatus that performs a predetermined operation. In such a situation, depending on an object, information acquired by a line-scan type vision sensor may be sufficient. In other words, there is a case where desired processing or determination can be performed based on position information of an object on a straight line. However, in order to execute processing with a line-scan type, there is a problem in that a line-scan type vision sensor needs to be provided in addition to an area-scan type vision sensor.

A processing device according to an aspect of the present disclosure includes a vision sensor configured to acquire information on a surface of an object placed in an imaging region. The processing device includes a position information generation unit configured to generate position information of the surface of the object in three dimensions based on the information on the surface of the object. The processing device includes a cutting line setting unit configured to set a cutting line for acquiring a cross-sectional image of the surface of the object by manipulating the position information of the surface of the object. The processing device includes a cross-sectional image generation unit configured to create a cross-sectional image in two dimensions, which is obtained by cutting the surface of the object based on the position information of the surface of the object corresponding to the cutting line set by the cutting line setting section.

A processing method according to an aspect of the present disclosure includes imaging an object by a vision sensor configured to acquire information on a surface of the object placed in an image capturing region. The processing method includes generating position information of the surface of the object in three dimensions by a position information generation unit based on the information on the surface of the object. The processing method includes setting a cutting line by a cutting line setting unit for acquiring a cross-sectional image of the surface of the object by manipulating the position information of the surface of the object. The processing method includes creating a cross-sectional image in two dimensions by a cross-sectional image generation unit, which is obtained by cutting the surface of the object based on the position information of the surface of the object corresponding to the cutting line set by the cutting line setting section.

According to an aspect of the present disclosure, it is possible to provide a processing device and a processing method for generating a cross-sectional image of a surface of an object from three-dimensional position information of the surface of the object placed in an image capturing region of a vision sensor.

### BRIEF DESCRIPTION OF DRAWINGS

FIG. 1 is a perspective view of a first robot apparatus in an embodiment.

FIG. 2 is a block diagram of the first robot apparatus in the embodiment.

FIG. 3 is a schematic diagram of a vision sensor in the embodiment.

FIG. 4 is a perspective view illustrating three-dimensional points generated by a position information generation unit in the embodiment.

FIG. 5 is a flowchart of control for displaying a cross-sectional image of a surface of a workpiece by the first robot apparatus.

FIG. 6 is a distance image generated by the position information generation unit.

FIG. 7 is a cross-sectional image of a surface of a first workpiece generated by a cross-sectional image generation unit.

FIG. 8 is a perspective view illustrating relative positions of the first workpiece and the vision sensor when imaging is performed with the vision sensor inclined.

FIG. 9 is a cross-sectional image of a surface of a workpiece and a surface of a platform in a sensor coordinate system.

FIG. 10 is a cross-sectional image of a surface of a workpiece and a surface of a platform in a robot coordinate system.

FIG. 11 is a perspective view of a second workpiece and the vision sensor when the second workpiece is imaged in the embodiment.

FIG. 12 is a distance image of the second workpiece.

FIG. 13 is a cross-sectional image of a surface of the second workpiece.

FIG. 14 is a block diagram of a second robot apparatus in the embodiment.

FIG. 15 is a flowchart of control for generating a reference cross-sectional image by the second robot apparatus.

FIG. 16 is the reference cross-sectional image generated by the second robot apparatus.

FIG. 17 is a flowchart of control for correcting a position and an orientation of a robot.

FIG. 18 is a schematic view of a third robot apparatus in the embodiment.

### DETAILED DESCRIPTION OF EMBODIMENTS OF THE INVENTION

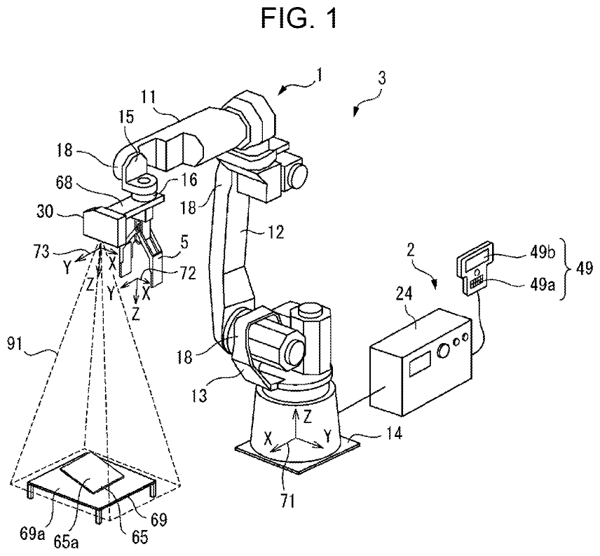

A processing device and a processing method in an embodiment will be described with reference to FIGS. 1 to 18. The processing device of the present embodiment processes an output of a vision sensor that acquires information on a surface of an object. The vision sensor of the present embodiment is not a line-scan type sensor that detects position information of a surface along a line, but is an area-scan type sensor that detects position information of a surface over a region (surface). First, a processing device disposed in a robot apparatus including a robot that changes the position of an operation tool will be described.

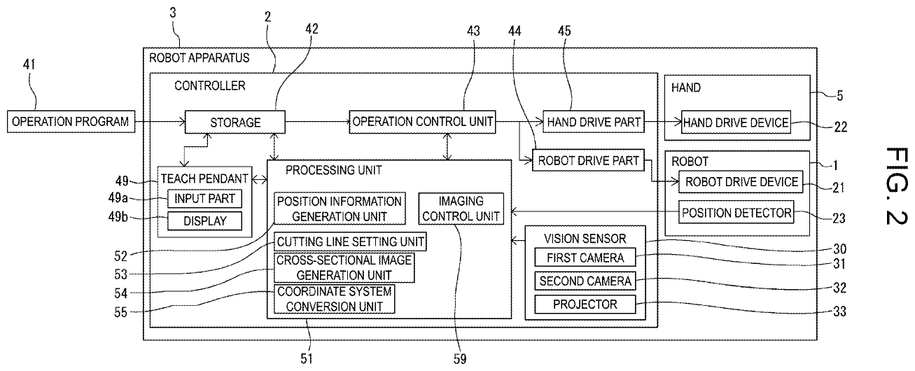

FIG. 1 is a perspective view of a first robot apparatus in the present embodiment. FIG. 2 is a block diagram of the first robot apparatus in the present embodiment. Referring to FIGS. 1 and 2, a first robot apparatus 3 includes a hand 5 as an operation tool for grasping a workpiece 65 and a robot 1 that moves the hand 5. The robot apparatus 3 includes a controller 2 that controls the robot 1 and the hand 5. The robot apparatus 3 includes a vision sensor 30 that acquires information on a surface of the workpiece 65 as an object.

The first workpiece 65 of the present embodiment is a plate-like member including a surface 65a having a planar shape. The workpiece 65 is supported by a platform 69 including a surface 69a. The hand 5 is an operation tool that grasps and releases the workpiece 65. The operation tool attached to the robot 1 is not limited to this configuration, and any operation tool can be employed according to operation performed by the robot apparatus 3. For example, an operation tool that performs welding or an operation tool that applies a sealing material can be employed. The processing device of the present embodiment can be applied to a robot apparatus that performs any operation.

The robot 1 of the present embodiment is an articulated robot having a plurality of joints 18. The robot 1 includes an upper arm 11 and a lower arm 12. The lower arm 12 is supported by a turning base 13. The turning base 13 is supported by a base 14. The robot 1 includes a wrist 15 that is coupled to an end portion of the upper arm 11. The wrist 15 includes a flange 16 that fixes the hand 5. The robot 1 of the present embodiment includes six drive axes, but is not limited to this configuration, i.e. any robot that can move the operation tool can be employed.

The vision sensor 30 is fixed to the flange 16 via a support member 68. The vision sensor 30 of the present embodiment is supported by the robot 1 such that the position and the orientation of the vision sensor 30 is changed together with the hand 5.

The robot 1 of the present embodiment includes a robot drive device 21 that drives constituent members, such as the upper arm 11. The robot drive device 21 includes a plurality of drive motors for driving the upper arm 11, the lower arm 12, the turning base 13, and the wrist 15. The hand 5 includes a hand drive device 22 that drives the hand 5. The hand drive device 22 of the present embodiment drives the hand 5 by air pressure. The hand drive device 22 includes a pump, an electromagnetic valve, and the like for driving fingers of the hand 5.

The controller 2 includes an arithmetic processing device 24 (computer) that includes a central processing unit (CPU) as a processor. The arithmetic processing device 24 includes a random access memory (RAM), a read only memory (ROM), and the like that are mutually connected to the CPU via a bus. In the robot apparatus 3, the robot 1 and the hand 5 are driven in accordance with an operation program 41. The robot apparatus 3 of the present embodiment has a function of automatically conveying the workpiece 65.

The arithmetic processing device 24 of the controller 2 includes a storage 42 for storing information relating to the control of the robot apparatus 3. The storage 42 can be formed of a non-transitory storage medium that can store information. For example, the storage 42 can be composed of a storage medium such as a volatile memory, a nonvolatile memory, a magnetic storage medium, an optical storage medium or the like. The operation program 41 generated in advance for operating the robot 1 is input to the controller 2. The operation program 41 is stored in the storage 42.

The arithmetic processing device 24 includes an operation control unit 43 for transmitting an operation command. The operation control unit 43 transmits an operation command for driving the robot 1 to a robot drive part 44 based on the operation program 41. The robot drive part 44 includes an electric circuit that drives a drive motor. The robot drive part 44 supplies electricity to the robot drive device 21 based on the operation command. The operation control unit 43 transmits an operation command for driving the hand drive device 22 to a hand drive part 45. The hand drive part 45 includes an electric circuit that drives a pump and the like. The hand drive part 45 supplies electricity to the hand drive device 22 based on the operation command.

The operation control unit 43 is equivalent to a processor that is driven in accordance with the operation program 41. The processor reads the operation program 41 and performs the control defined in the operation program 41, thereby functioning as the operation control unit 43.

The robot 1 includes a state detector for detecting the position and the orientation of the robot 1. The state detector of the present embodiment includes a position detector 23 attached to the drive motor of each drive axis of the robot drive device 21. The position detector 23 is composed of, for example, an encoder. By the output from the position detector 23, the position and the orientation of the robot 1 are detected.

The controller 2 includes a teach pendant 49 as an operation panel on which an operator manually operates the robot apparatus 3. The teach pendant 49 includes an input part 49a for inputting information relating to the robot 1, the hand 5, and the vision sensor 30. The input part 49a is composed of an operation member such as a keyboard and a dial. The teach pendant 49 includes a display 49b that displays information on the control of the robot apparatus 3. The display 49b is composed of a display panel such as a liquid crystal display panel.

A robot coordinate system 71 that is immovable when the position and the orientation of the robot 1 are changed is set to the robot apparatus 3 of the present embodiment. In the example illustrated in FIG. 1, the origin of the robot coordinate system 71 is arranged at the base 14 of the robot 1. The robot coordinate system 71 is also referred to as a world coordinate system or a reference coordinate system. In the robot coordinate system 71, the position of the origin is fixed, and the directions of the coordinate axes are fixed. Even when the position and the orientation of the robot 1 are changed, the position and the orientation of the robot coordinate system 71 are not changed. The robot coordinate system 71 of the present embodiment is set such that the z-axis is parallel to the vertical direction.

In the robot apparatus 3, a tool coordinate system 72 having an origin set at any position of an operation tool is set. The position and the orientation of the tool coordinate system 72 are changed together with the hand 5. The origin of the tool coordinate system 72 of the present embodiment is set at a tool tip point. For example, the position of the robot 1 corresponds to a position of the tool center point (the position of the origin of the tool coordinate system 72). Further, the orientation of the robot 1 corresponds to the orientation of the tool coordinate system 72 with respect to the robot coordinate system 71.

Further, in the robot apparatus 3, a sensor coordinate system 73 is set with respect to the vision sensor 30. The sensor coordinate system 73 is a coordinate system whose origin is fixed at any position of the vision sensor 30. The position and the orientation of the sensor coordinate system 73 are changed together with the vision sensor 30. The sensor coordinate system 73 of the present embodiment is set such that the Z-axis is parallel to an optical axis of a camera included in the vision sensor 30.

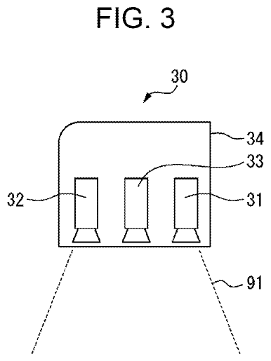

FIG. 3 is a schematic view of the vision sensor of the present embodiment. The vision sensor of the present embodiment is a three-dimensional camera that can acquires three-dimensional position information of a surface of an object. Referring to FIGS. 2 and 3, the vision sensor 30 of the present embodiment is a stereo camera including a first camera 31 and a second camera 32. Each of the cameras 31 and 32 is a two-dimensional camera that can capture a two-dimensional image. The two cameras 31 and 32 are arranged apart from each other. The relative positions of the two cameras 31 and 32 are predetermined. The vision sensor 30 of the present embodiment includes a projector 33 that projects a pattern light such as a stripe pattern toward the workpiece 65. The cameras 31 and 32 and the projector 33 are arranged inside a housing 34.

The processing device of the robot apparatus 3 of the present embodiment processes information acquired by the vision sensor 30. In the present embodiment, the controller 2 functions as the processing device. The arithmetic processing device 24 of the controller 2 includes a processing unit 51 that processes the output of the vision sensor 30.

The processing unit 51 includes a position information generation unit 52 that generates three-dimensional position information of the surface of the workpiece 65 based on the information on the surface of the workpiece 65 output from the vision sensor 30. The processing unit 51 includes a cutting line setting unit 53 that sets a cutting line for the surface of the workpiece 65 through manipulation of the position information on the surface of the workpiece 65. The cutting line setting unit 53 sets a cutting line to acquire a cross-sectional image of the surface 65a of the workpiece 65. The cutting line setting unit 53 sets a cutting line through manipulation of the position information of the surface of the workpiece 65 by a person or a machine.

The processing unit 51 includes a cross-sectional image generation unit 54 that creates a two-dimensional cross-sectional image based on the position information of the surface of the workpiece 65 corresponding to the cutting line set by the cutting line setting unit 53. The cross-sectional image generation unit 54 creates a cross-sectional image obtained by cutting the surface of the workpiece 65 along the cutting line.

The processing unit 51 includes a coordinate system conversion unit 55 that converts the position information of the surface of the workpiece 65 acquired in the sensor coordinate system 73 into the position information of the surface of the workpiece 65 represented in the robot coordinate system 71. The coordinate system conversion unit 55 has, for example, a function of converting a position (coordinate values) of a three-dimensional point in the sensor coordinate system 73 into a position (coordinate values) of a three-dimensional point in the robot coordinate system 71. The processing unit 51 includes an imaging control unit 59 that transmits a command for imaging the workpiece 65 to the vision sensor 30.

The processing unit 51 described above is equivalent to a processor that is driven in accordance with the operation program 41. The processor performs the control defined in the operation program 41, thereby functioning as the processing unit 51. In addition, the position information generation unit 52, the cutting line setting unit 53, the cross-sectional image generation unit 54, the coordinate system conversion unit 55, and the imaging control unit 59 included in the processing unit 51 are equivalent to a processor that is driven in accordance with the operation program 41. The processor performs the control defined in the operation program 41, thereby functioning as the respective units.

The position information generation unit 52 of the present embodiment calculates a distance from the vision sensor 30 to a three-dimensional point set on a surface of an object based on parallax between an image captured by the first camera 31 and an image captured by the second camera 32. The three-dimensional point can be set for each pixel of an image sensor, for example. The distance from the vision sensor 30 to the three-dimensional point is calculated based on a difference between a position of a pixel of a predetermined part of the object in one image and a position of a pixel of a predetermined part of the object in the other image. The position information generation unit 52 calculates a distance from the vision sensor 30 to each three-dimensional point. The position information generation unit 52 calculates coordinate values of a position of a three-dimensional point in the sensor coordinate system 73 based on the distance from the vision sensor 30.

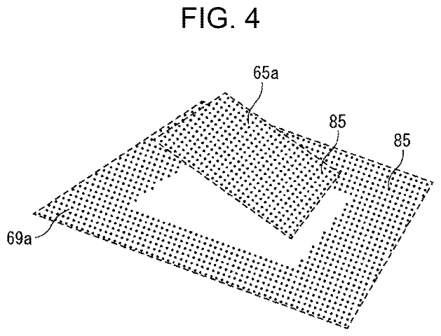

FIG. 4 illustrates a perspective view of a group of three-dimensional points generated by the position information generation unit. FIG. 4 is a perspective view of three-dimensional points arranged in a three-dimensional space. In FIG. 4, the contour of the workpiece 65 and the contour of the platform 69 are indicated by broken lines. A three-dimensional point 85 is located on a surface of an object facing the vision sensor 30. The position information generation unit 52 sets the three-dimensional point 85 with respect to the surface of the object included in an imaging region 91. Here, a large number of three-dimensional points 85 are arranged on the surface 65a of the workpiece 65. Also, a large number of three-dimensional points 85 are arranged on the surface 69a of the platform 69.

The position information generation unit 52 can present three-dimensional position information of the surface of the object in the perspective view of the group of the three-dimensional points as described above. Also, the position information generation unit 52 can generate the three-dimensional position information of the surface of the object in a form of a distance image or a three-dimensional map. The distance image represents the position information of the surface of the object by a two-dimensional image. The distance image indicates distances from the vision sensor 30 to the three-dimensional points by depths or colors of respective pixels. On the other hand, the three-dimensional map represents the position information of the surface of the object by a set of coordinate values (x, y, z) of the three-dimensional points on the surface of the object. The coordinate values at this time can be represented in an arbitrary coordinate system such as the sensor coordinate system or the robot coordinate system.

In the present embodiment, three-dimensional position information of a surface of an object will be described by using a distance image as an example. The position information generation unit 52 of the present embodiment generates a distance image in which depth of color is changed depending on distances from the vision sensor 30 to the three-dimensional points 85.

The position information generation unit 52 of the present embodiment is disposed at the processing unit 51 of the arithmetic processing device 24, but is not limited to this configuration. The position information generation unit may be disposed inside the vision sensor. That is, the vision sensor may include an arithmetic processing device including a processor such as a CPU, and the processor of the arithmetic processing device of the vision sensor may function as the position information generation unit. In that case, a three-dimensional map, a distance image, or the like is output from the vision sensor.

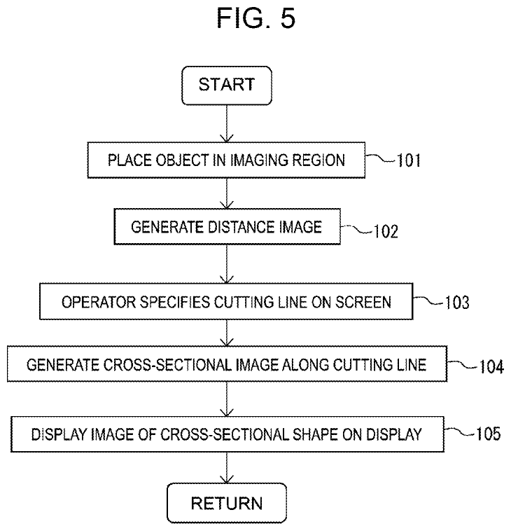

FIG. 5 illustrates a flowchart of control for generating a cross-sectional image of a surface of a workpiece by the first robot apparatus. Referring to FIGS. 1, 2, and 5, in step 101, a process of arranging the workpiece 65 in the imaging region 91 of the vision sensor 30 is performed. An operator places the workpiece 65 on the platform 69.

In the first robot apparatus 3, the position and the orientation of the platform 69 and the position and the orientation of the workpiece 65 with respect to the platform 69 are predetermined. That is, the position and the orientation of the workpiece 65 in the robot coordinate system 71 are predetermined. Also, the position and the orientation of the robot 1 at the time when the workpiece 65 is imaged are predetermined. The workpiece 65 is supported so as to be inclined with respect to the surface 69a of the platform 69. In the example illustrated in FIG. 1, the position and the orientation of the robot 1 are controlled such that directions of visual lines of the cameras of the vision sensor 30 are parallel to the vertical direction. That is, the direction of the Z-axis of the sensor coordinate system 73 is parallel to the vertical direction.

Next, in step 102, the vision sensor 30 performs a process of imaging the workpiece 65 and the platform 69. The imaging control unit 59 transmits a command for performing imaging to the vision sensor 30. The position information generation unit 52 performs a process of generating a distance image as the position information of the surface 65a of the workpiece 65 based on the output of the vision sensor 30.

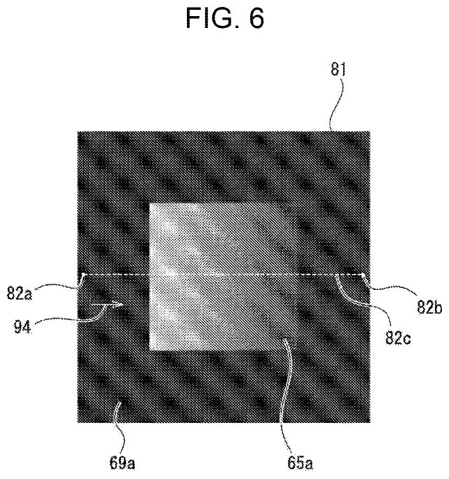

FIG. 6 illustrates a distance image generated by the position information generation unit. In a distance image 81, the depth of color is changed depending on the distances of the three-dimensional points. Here, generation is made such that the larger the distance from the vision sensor 30 is, the deeper the color is. The display 49b of the teach pendant 49 displays the distance image 81 as the position information of the surface of the object.

Next, in step 103, the cutting line setting unit 53 performs a process of setting a cutting line for acquiring a cross-sectional image of the surface 65a of the workpiece 65 through manipulation of the distance image 81. The operator can manipulate the image displayed on the display 49b by operating the input part 49a of the teach pendant 49. The operator specifies a line on the distance image 81 of the workpiece 65 displayed on the display 49b. The cutting line setting unit 53 sets this line as a cutting line 82c.

In the example here, when specifying the cutting line 82c on the distance image 81, the operator specifies a start point 82a and an end point 82b. Then, the operator operates the input part 49a so as to connect the start point 82a and the end point 82b with a straight line. Alternatively, the operator can specify a line by moving an operating point from the start point 82a in a direction indicated by an arrow 94. The cutting line setting unit 53 acquires the position of the line in the distance image 81 specified through the manipulation by the operator. The cutting line setting unit 53 sets this line as the cutting line 82c. The storage 42 stores the distance image 81 and the position of the cutting line 82c in the distance image 81.

Next, in step 104, the cross-sectional image generation unit 54 performs a process of creating a two-dimensional cross-sectional image obtained by cutting the surface of the workpiece 65. The cross-sectional image generation unit 54 generates the cross-sectional image based on the position information of the surface 65a of the workpiece 65 and the surface 69a of the platform 69 corresponding to the cutting line 82c set by the cutting line setting unit 53.

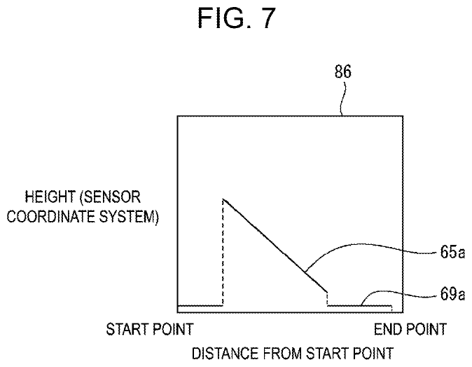

FIG. 7 illustrates a cross-sectional image of the surfaces of the workpiece and the platform generated by the cross-sectional image generation unit. The cross-sectional image generation unit 54 acquires the position information of the surfaces corresponding to the cutting line 82c. For example, the cross-sectional image generation unit 54 acquires coordinate values as the positions of three-dimensional points arranged along the cutting line 82c. The coordinate values are represented in the sensor coordinate system 73, for example. Alternatively, the cross-sectional image generation unit 54 acquires distances from the vision sensor 30 to the three-dimensional points as the positions of the three-dimensional points.

In the cross-sectional image illustrated in FIG. 7, the height is set to 0 at an installation surface on which the platform 69 is installed. The cross-sectional image generation unit 54 can calculate the heights of the three-dimensional points from the installation surface based on the distances from the vision sensor 30 or the coordinate values of the three-dimensional points. Then, a cross-sectional image 86 is generated by connecting the three-dimensional points adjacent to each other with a line. The cross-sectional image 86 represents a two-dimensional cross-sectional shape obtained by cutting the surface 65a of the workpiece 65 and the surface 69a of the platform 69 along the cutting line 82c.

In step 105, the display 49b of the teach pendant 49 displays the cross-sectional image 86 generated by the cross-sectional image generation unit 54. The operator can perform any operation while viewing the cross-sectional image 86 displayed on the display 49b. For example, the shape or the dimensions of the surface of the workpiece 65 can be inspected. Alternatively, a position of an arbitrary point on the cutting line 82c can be acquired.

As described above, the processing device and the processing method of the present embodiment can generate a cross-sectional image of a surface of an object by using an area-scan type vision sensor. In particular, the processing device and the processing method of the present embodiment can generate a cross-sectional image like a cross-sectional image generated by a line-scan type vision sensor.

The cutting line setting unit sets a line specified on a distance image by an operator as a cutting line. By performing this control, it is possible to generate a cross-sectional image of any portion of the distance image. Thus, a cross-sectional image of a portion desired by the operator can be generated.

In the state illustrated in FIG. 1, the direction of the Z-axis of the sensor coordinate system 73 is parallel to the vertical direction. Also, the direction of the Z-axis of the robot coordinate system 71 is parallel to the vertical direction. Thus, an image of a cross-sectional shape of the surface 65a of the workpiece 65 represented in the sensor coordinate system 73 and an image of a cross-sectional shape of the surface 65a of the workpiece 65 represented in the robot coordinate system 71 are similar to each other. However, when the position and the orientation of the robot 1 are changed, it may be difficult to grasp the cross-sectional shape of the surface of the workpiece in the cross-sectional image represented in the sensor coordinate system 73.

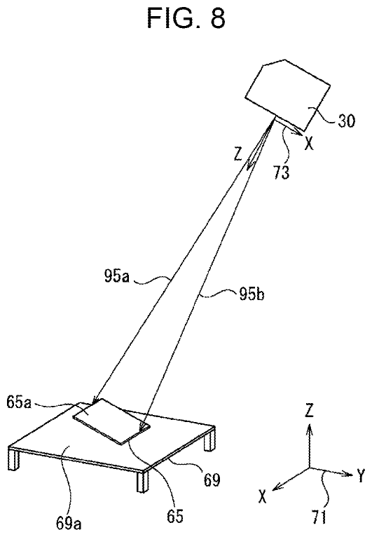

FIG. 8 illustrates a perspective view when the workpiece is imaged with the vision sensor inclined. The direction of the Z-axis of the sensor coordinate system 73 is inclined with respect to the vertical direction. Further, in this example, the direction of the Z-axis of the sensor coordinate system 73 and a normal line of the surface 65a of the workpiece 65 are parallel to each other. Furthermore, a distance from the origin of the sensor coordinate system 73 to one end of the surface 65a and a distance from the origin of the sensor coordinate system 73 to the other end of the surface 65a are equal to each other. In other words, the distance indicated by an arrow 95a is equal to the distance indicated by an arrow 95b.

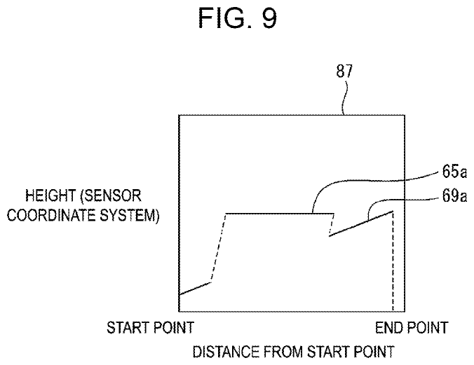

FIG. 9 illustrates a cross-sectional image generated in the sensor coordinate system. A cross-sectional image 87 is generated based on coordinate values in the sensor coordinate system 73. The direction of the Z-axis of the sensor coordinate system 73 corresponds to a height direction. In the direction of the Z-axis of the sensor coordinate system 73, the height is determined to be 0 at a position of a surface separated from the vision sensor 30 by a predetermined distance. In the cross-sectional image 87, the height of the surface 65a of the workpiece 65 is constant. On the other hand, the height of the surface 69a of the platform 69 changes as the distance from the start point changes.

While the surface 65a of the workpiece 65 is actually inclined with respect to the horizontal direction, the height of the surface 65a is constant in the cross-sectional image 87. In this way, when the cross-sectional image is generated based on the sensor coordinate system 73, it may be difficult to grasp the cross-sectional shape of the surface. Referring to FIG. 2, the coordinate system conversion unit 55 of the present embodiment can convert the position information of the surface 65a of the workpiece 65 generated in the sensor coordinate system 73 into the position information of the surface 65a of the workpiece 65 represented in the robot coordinate system 71.

For example, the coordinate system conversion unit 55 can calculate the position and the orientation of the sensor coordinate system 73 with respect to the robot coordinate system 71 based on the position and the orientation of the robot 1. For this purpose, the coordinate system conversion unit 55 can convert the coordinate values of three-dimensional points in the sensor coordinate system 73 into the coordinate values of three-dimensional points in the robot coordinate system 71. The cross-sectional image generation unit 54 can generate a cross-sectional image represented in the robot coordinate system 71 based on the position information of the surface 65a of the workpiece 65 represented in the robot coordinate system 71.

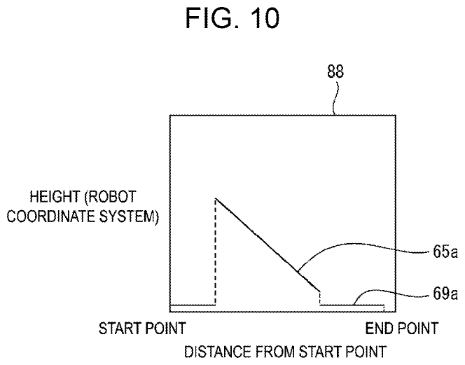

FIG. 10 illustrates a cross-sectional image of the surfaces of the workpiece and the platform generated in the robot coordinate system. In a cross-sectional image 88, the direction of the Z-axis of the robot coordinate system 71 is a height direction. The direction of the Z-axis of the robot coordinate system 71 of the present embodiment is parallel to the vertical direction. Thus, the height of the surface 69a of the platform 69 is constant. A cross-sectional image in which the surface 65a of the workpiece 65 is inclined is obtained. The cross-sectional image 88 is the same as the cross-sectional image 86 illustrated in FIG. 7. In this way, by the function of the coordinate system conversion unit 55, the cross-sectional image represented in the sensor coordinate system 73 can be converted into the cross-sectional image represented in the robot coordinate system 71. By this control, the operator can easily see the cross-sectional shape of the surface of the workpiece.

Next, the robot apparatus of the present embodiment can generate a cross-sectional image of a surface of a workpiece obtained by cutting the surface along a curved line.

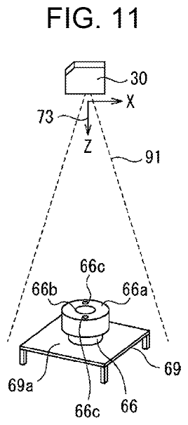

FIG. 11 illustrates a perspective view of a second workpiece and the vision sensor when the second workpiece is imaged. A second workpiece 66 is a member having a flange shape. A hole 66b is formed at a central portion of the workpiece 66 so as to penetrate the workpiece 66 along a central axis. Two holes 66c each having a bottom surface are formed in the flange portion of the workpiece 66. In this example, the vision sensor 30 is arranged such that the direction of the Z-axis of the sensor coordinate system 73 is parallel to the vertical direction. The workpiece 66 is fixed to the platform 69 such that a surface 66a is parallel to the horizontal direction. In this example, the workpiece 66 is fixed at a predetermined position of the platform 69. That is, the position of the workpiece 66 in the robot coordinate system 71 is predetermined.

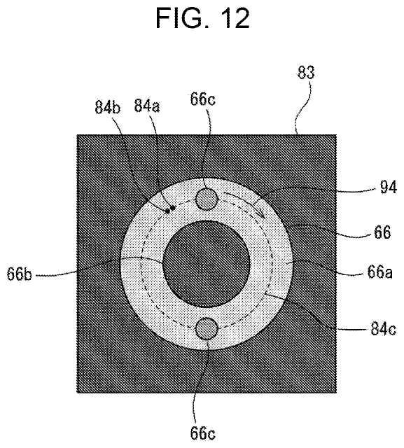

FIG. 12 illustrates a distance image when the second workpiece is imaged. The position information generation unit 52 acquires information on the surface 66a of the workpiece 66 and the surface 69a of the platform 69 obtained by the vision sensor 30. In this case, images captured by the two cameras 31 and 32 are acquired. The position information generation unit 52 generates a distance image 83. The surface 66a of the workpiece 66 and the holes 66b and 66c are illustrated in the distance image 83. The distance image 83 is generated such that the larger the distance from the vision sensor 30 is, the deeper the color is.

Next, the operator specifies a cutting line for acquiring a cross-sectional image. The operator operates the input part 49a of the teach pendant 49 so as to draw a line serving as a cutting line 84c on the distance image 83. Here, the operator specifies a start point 84a and an end point 84b of the cutting line 84c. The operator specifies the shape of the cutting line 84c as a circle. In addition, the operator inputs conditions necessary for generating a circle, such as a radius of the circle and a center of the circle. The cutting line setting unit 53 generates the cutting line 84c having a circular shape from the start point 84a toward the end point 84b as indicated by an arrow 94. In this case, the cutting line 84c is formed so as to pass through the central axes of the two holes 66c formed in the flange portion. Alternatively, the operator may specify the cutting line 84c by manually drawing a line on the distance image 83 along the direction indicated by the arrow 94.

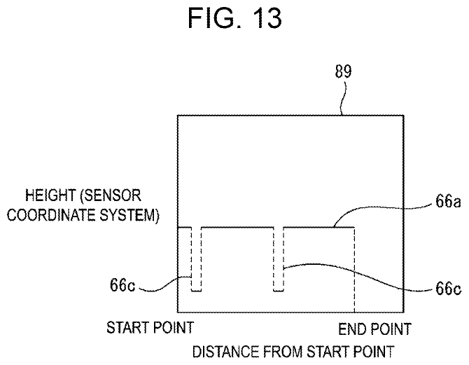

FIG. 13 illustrates a cross-sectional image of the second workpiece. Next, the cross-sectional image generation unit 54 generates a cross-sectional image 89 obtained by cutting the surface 66a of the workpiece 66 along the cutting line 84c. In this case, the cross-sectional image 89 is generated in the sensor coordinate system 73. The height of the surface 66a is constant from the start point 84a toward the end point 84b. Recesses corresponding to respective holes 66c are indicated.

The operator can perform any operation such as inspection of the workpiece 66 by using the cross-sectional image 89. For example, the operator can inspect the number, the shape, the depth, or the like of the holes 66c. Alternatively, the operator can check the size of a recess or a protrusion of the surface 66a. For this purpose, the operator can inspect the flatness of the surface 66a of the workpiece 66. Alternatively, the position of the surface and the positions of the holes 66c can be checked.

As described above, the processing device of the present embodiment can generate a cross-sectional image obtained by cutting a surface of an object along a curved line. The shape of the cutting line is not limited to a straight line and a circle, and a cutting line having any shape can be specified. For example, the cutting line may be formed by a free curve. Further, a cutting line may be set at a plurality of locations for one workpiece, and cross-sectional images along the respective cutting lines may be generated.

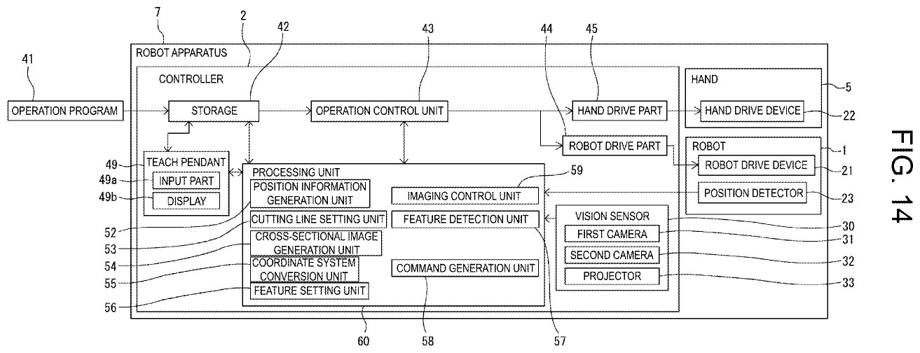

FIG. 14 illustrates a block diagram of a second robot apparatus according to the present embodiment. A second robot apparatus 7 performs image processing on a cross-sectional image generated by the cross-sectional image generation unit 54. In the second robot apparatus 7, the configuration of a processing unit 60 is different from that of the processing unit 51 (see FIG. 2) of the first robot apparatus 3. The processing unit 60 of the second robot apparatus 7 includes a feature detection unit 57 that detects a feature portion of an object in an image. The feature portion is a portion having a distinctive shape in an image.

The feature detection unit 57 detects a feature portion of a surface of an object by performing a matching between a cross-sectional image of the object generated by imaging this time and a predetermined reference cross-sectional image. The feature detection unit 57 of the present embodiment performs a pattern matching among image matchings. The feature detection unit 57 can detect a position of a feature portion in the cross-sectional image. The processing unit 60 includes a command generation unit 58 that generates a command for setting the position and the orientation of the robot 1 based on the position of the feature portion. The command generation unit 58 transmits a command for changing the position and the orientation of the robot 1 to the operation control unit 43. Then, the operation control unit 43 changes the position and the orientation of the robot 1.

Further, the processing unit 60 of the second robot apparatus 7 has a function of generating a reference cross-sectional image that is a cross-sectional image serving as a reference when performing a pattern matching. The vision sensor 30 images a reference object that is an object serving as a reference for generating the reference cross-sectional image. The position information generation unit 52 generates position information of the surface of the object serving as a reference. The cross-sectional image generation unit 54 generates a reference cross-sectional image that is a cross-sectional image of the surface of the object serving as a reference. The processing unit 60 includes a feature setting unit 56 that sets a feature portion of the object in the reference cross-sectional image. The storage 42 can store information on the output of the vision sensor 30. The storage 42 stores the generated reference cross-sectional image and the position of the feature portion in the reference cross-sectional image.

Each of the feature detection unit 57, the command generation unit 58, and the feature setting unit 56 described above is equivalent to a processor that is driven in accordance with the operation program 41. The processor performs the control defined in the operation program 41, thereby functioning as the respective units.

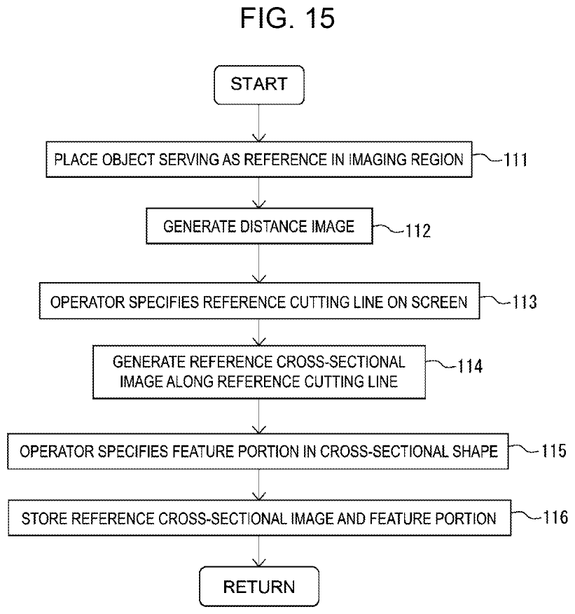

FIG. 15 illustrates a flowchart of control for generating a reference cross-sectional image. Here, similarly to the first robot apparatus 3 illustrated in FIG. 1, an example of conveying the first workpiece 65 will be described as operation performed by the second robot apparatus 7. In this control, a reference cross-sectional image serving as a reference is generated in order to perform a pattern matching for the cross-sectional image 86 (see FIG. 7) of the surface of the workpiece 65. Referring to FIGS. 1, 14, and 15, the operator prepares a workpiece serving as a reference for generating a reference cross-sectional image. In this case, the workpiece as a reference object is referred to as a reference workpiece. The reference workpiece has the same shape as the first workpiece 65.

In step 111, the reference workpiece is placed in the imaging region 91 of the vision sensor 30. The position of the platform 69 in the robot coordinate system 71 is predetermined. The operator places the reference workpiece at a predetermined position of the platform 69. In this way, the reference workpiece is placed at a predetermined position in the robot coordinate system 71. The position and the orientation of the robot 1 are changed to a predetermined position and a predetermined orientation for imaging the reference workpiece.

In step 112, the vision sensor 30 images the reference workpiece and acquires information on the surface of the reference workpiece. The position information generation unit 52 generates a distance image of the reference workpiece. The display 49b displays the distance image of the reference workpiece. In the present embodiment, the distance image of the reference workpiece is referred to as a reference distance image.

Next, in step 113, the operator specifies a reference cutting line, which is a cutting line serving as a reference, on the reference distance image displayed on the display 49b. For example, as illustrated in FIG. 6, a line is specified so as to pass through the center in a width direction of the surface 65a of the workpiece 65. The cutting line setting unit 53 sets this line as the cutting line 82c. In this way, the cutting line setting unit 53 sets the cutting line in accordance with the operation on the input part 49a by the operator. The storage 42 stores the position of the cutting line in the reference distance image obtained by imaging the reference workpiece.

Next, in step 114, the cross-sectional image generation unit 54 generates a cross-sectional image along the cutting line. The cross-sectional image obtained from the reference workpiece is a reference cross-sectional image. That is, the cross-sectional image of the reference workpiece generated by the cross-sectional image generation unit 54 serves as a reference cross-sectional image when performing a pattern matching of cross-sectional images.

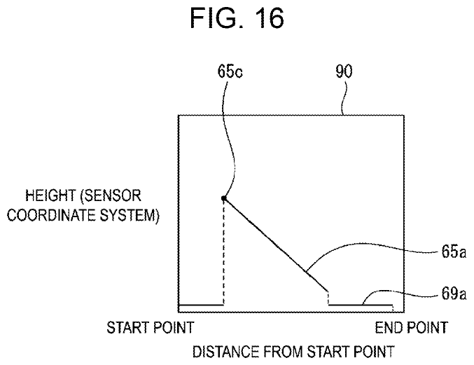

FIG. 16 illustrates an example of a reference cross-sectional image generated by imaging a reference workpiece. A reference cross-sectional image 90 is generated by imaging a plate-like reference workpiece corresponding to the first workpiece. In this case, the reference cross-sectional image 90 generated in the sensor coordinate system 73 is illustrated. The reference cross-sectional image 90 is displayed on the display 49b.

Next, in step 115, the operator specifies a feature portion of the workpiece in the reference cross-sectional image 90. The operator specifies a feature portion in the reference cross-sectional image 90 by operating the input part 49a. Here, the operator specifies the highest point on the surface 65a of the reference workpiece as a feature portion 65c. The feature setting unit 56 sets a portion specified by the operator as a feature portion. The feature setting unit 56 detects the position of the feature portion 65c in the reference cross-sectional image 90. In this way, the operator can teach the position of the feature portion in the cross-sectional image. The feature portion is not limited to a point, and may be composed of a line or a figure.

Next, in step 116, the storage 42 stores the reference cross-sectional image 90 generated by the cross-sectional image generation unit 54. The storage 42 stores the position of the feature portion 65c in the reference cross-sectional image 90 set by the feature setting unit 56. Alternatively, the storage 42 stores the position of the feature portion 65c in the cross-sectional shape of the surface of the reference workpiece.

In the present embodiment, the reference cross-sectional image is generated by imaging the reference workpiece with the vision sensor, but the embodiment is not limited to this. The reference cross-sectional image can be created in any method. The processing unit of the controller need not have a function of generating a reference cross-sectional image. For example, three-dimensional shape data of a workpiece and a platform may be created by using a computer aided design (CAD) device, and a reference cross-sectional image may be generated based on the three-dimensional shape data.

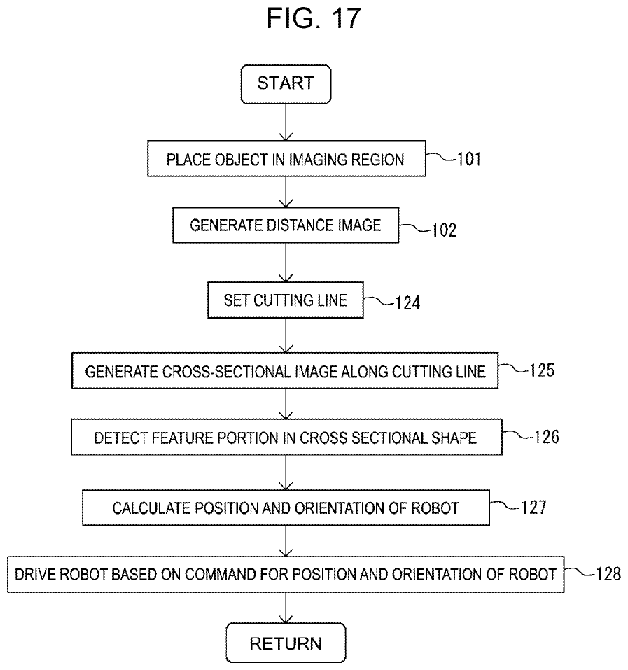

FIG. 17 illustrates a flowchart of control when a robot apparatus performs operation on a workpiece. In this control, the position and the orientation of a robot are adjusted by using a cross-sectional image generated by a processing unit.

Referring to FIGS. 14 and 17, in step 101, the workpiece 65 as an object of the operation is placed in the imaging region 91 of the vision sensor 30. The workpiece 65 is placed at a predetermined position in the robot coordinate system 71. In step 102, the vision sensor 30 images the surface 65a of the workpiece 65. The position information generation unit 52 generates a distance image of the surface 65a of the workpiece 65.

In step 124, the cutting line setting unit 53 sets a cutting line for the distance image of the workpiece 65. At this time, the cutting line setting unit 53 can set a cutting line for the distance image acquired this time based on the position of the cutting line in the reference distance image. For example, a cutting line is set at a predetermined position of the distance image as illustrated in FIG. 6. In this way, the cutting line setting unit 53 can automatically set a cutting line in accordance with a predetermined rule.

In step 125, the cross-sectional image generation unit 54 generates a cross-sectional image of the surface 65a of the workpiece 65 obtained by cutting the surface 65a of the workpiece 65 along the cutting line set by the cutting line setting unit 53.

Next, in step 126, the feature detection unit 57 performs a pattern matching between the reference cross-sectional image and the cross-sectional image acquired this time to identify a feature portion in the cross-sectional image of the surface 65a generated this time. For example, a feature portion in the cross-sectional image acquired this time is specified in correspondence with the feature portion 65c in the reference cross-sectional image 90 illustrated in FIG. 16. Then, the feature detection unit 57 detects the position of the feature portion. The position of the feature portion is detected by three-dimensional position information of the feature portion. The position of the feature portion is detected based on, for example, coordinate values of three-dimensional points in the robot coordinate system, a distance from the vision sensor, or the like.

In step 127, the command generation unit 58 calculates the position and the orientation of the robot 1 at the time when the workpiece is grasped based on the position of the feature portion in the cross-sectional image acquired this time. Alternatively, in a case where the position and the orientation of the robot 1 when the reference workpiece is grasped are determined, the command generation unit 58 may calculate correction amounts of the position and the orientation of the robot based on a difference between the position of the feature portion in the reference cross-sectional image 90 and the position of the feature portion in the cross-sectional image acquired this time.

In step 128, the command generation unit 58 transmits the position and the orientation of the robot 1 at the time when the workpiece is grasped to the operation control unit 43. The operation control unit 43 changes the position and the orientation of the robot 1 based on the command acquired from the command generation unit 58 and executes control for grasping the workpiece 65.

The second robot apparatus 7 can perform operation on the workpiece with accuracy by controlling the position and the orientation of the robot 1 based on the cross-sectional image. For example, even for workpieces having different dimensions due to manufacturing errors, operation can be performed on the workpieces with accuracy. Further, in the second robot apparatus 7, the processing unit 60 can set a cutting line so as to automatically generate a cross-sectional image of a surface of a workpiece. Furthermore, the position and the orientation of the robot 1 can be automatically adjusted by performing image processing on a cross-sectional image generated through imaging by the vision sensor 30.

In the above-described embodiment, the position and the orientation of the workpiece and the position and the orientation of the robot at the time of imaging are predetermined. That is, the position and the orientation of the workpiece and the position and the orientation of the robot 1 in the robot coordinate system 71 are constant, but the embodiment is not limited to this. In placing the workpiece at a position for imaging, the workpiece may be displaced from a desired position. For example, there may be a case where the position of the workpiece 65 on the platform 69 deviates from a reference position. In other words, the position of the workpiece 65 in the robot coordinate system 71 may be displaced from the reference position.

Therefore, the processing unit 60 may detect the position of the workpiece 65 by performing a pattern matching between a reference distance image of a reference workpiece and the distance image of the workpiece on which operation is to be performed. The processing unit 60 of the present embodiment can generate a reference distance image serving as a reference for performing a pattern matching of distance images. In step 112 in FIG. 15, the position information generation unit 52 generates a distance image of a reference workpiece. The storage 42 stores this distance image as a reference distance image. In step 113, the cutting line setting unit 53 sets a reference cutting line that is a cutting line in the reference workpiece. The storage 42 stores the position of the reference cutting line in the reference distance image.

The reference distance image can be generated in any method. For example, the reference distance image may be generated by using three-dimensional shape data of the workpiece and the platform generated by a CAD device.

Next, when the robot apparatus 7 performs the operation on a workpiece, control is performed so as to correct a position where the workpiece is placed by using a distance image of the workpiece and a reference distance image. Referring to FIG. 17, before step 124, the feature detection unit 57 detects the position of the workpiece in the distance image. The feature detection unit 57 detects the position of the workpiece in the captured distance image by performing a pattern matching between the reference distance image created in advance and the distance image acquired from the output of the vision sensor 30. For example, the contour of the workpiece is set as a feature portion, and a pattern matching with respect to the contour of the workpiece can be performed.

Next, in step 124, the cutting line setting unit 53 sets a cutting line for the captured distance image. The cutting line setting unit 53 sets the position of the cutting line based on the position of the reference cutting line with respect to the reference workpiece in the reference distance image. The cutting line setting unit 53 can set the position of the cutting line so as to respond to a displacement amount of the position of the feature portion of the workpiece in the captured distance image. For example, as illustrated in FIG. 6, the cutting line setting unit 53 can set the cutting line 82c so as to pass through the center in a width direction of the surface 65a of the workpiece 65. Then, the workpiece can be grasped by the same control as the control in and after step 125 described above. In this way, the position of the workpiece may be corrected based on the distance image captured by the vision sensor.

In the embodiment described above, the control for grasping the workpiece has been described as an example, but the embodiment is not limited to this. The robot apparatus can perform any operation. For example, the robot apparatus can perform operation for applying an adhesive to a predetermined portion of the workpiece, operation for performing welding, or the like.

Further, the second robot apparatus 7 can automatically perform inspection of a workpiece. Referring to FIGS. 11, 12, and 14, when the second robot apparatus 7 inspects the second workpiece 66, the feature detection unit 57 can detect the hole 66b as a feature portion by performing a pattern matching of distance images.

The cutting line setting unit 53 can set the cutting line 84c at a predetermined position with respect to the hole 66b. For example, the cutting line setting unit 53 can set the cutting line 84c having a circular shape whose center is arranged on the central axis of the hole 66b. Then, the cross-sectional image generation unit 54 generates a cross-sectional image along the cutting line 84c. The feature detection unit 57 can detect the holes 66c by performing a pattern matching with the reference cross-sectional image. Then, the processing unit 60 can detect the number, position, depth, or the like of the holes 66c. The processing unit 60 can perform inspections of the holes 66c in accordance with a predetermined determination range.

In the above-described embodiment, a pattern matching has been described as an example of a matching between the reference cross-sectional image and the cross-sectional image generated by the cross-sectional image generation unit, but the embodiment is not limited to this. For the matching of cross-sectional images, any matching method that can determine the position of a reference cross-sectional image in a cross-sectional image generated by the cross-sectional image generation unit can be employed. For example, the feature detection unit can perform a template matching including a sum of absolute difference (SAD) method or a sum of squared difference (SSD) method. As described above, the second robot apparatus performs image processing on the cross-sectional image generated by the cross-sectional image generation unit. Then, based on the result of the image processing, the position and the orientation of the robot can be corrected or the workpiece can be inspected.

The cutting line setting unit 53 of the second robot apparatus 7 can automatically set a cutting line by manipulating an acquired distance image. Thus, the operation, the inspection, or the like by the robot apparatus can be automatically performed. The cutting line setting unit can set a cutting line for a distance image acquired by the vision sensor based on a cutting line set for a reference distance image, but the embodiment is not limited to this. For example, a cutting line can be set in advance for a three-dimensional model of the workpiece generated by a CAD device. Then, the cutting line setting unit may set a cutting line for a distance image acquired by the vision sensor based on the cutting line specified for the three-dimensional model.

The processing device that generates a cross-sectional image described above is disposed at the robot apparatus including the robot, but the embodiment is not limited to this. The processing device can be applied to any apparatus that acquires a cross-sectional shape of a surface of a workpiece.

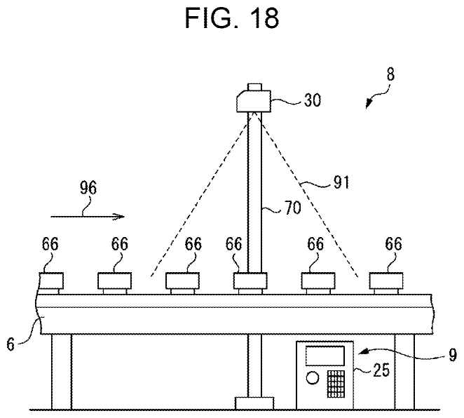

FIG. 18 illustrates a schematic diagram of an inspection device of the present embodiment. Here, a device for inspecting the second workpiece 66 illustrated in FIG. 11 will be described as an example. An inspection device 8 includes a conveyor 6 that conveys the workpiece 66 and a controller 9 for inspecting the workpiece 66. The controller 9 includes the vision sensor 30 and an arithmetic processing device 25 that processes the output of the vision sensor 30. The controller 9 functions as a processing device that generates a cross-sectional image of an object.

The conveyor 6 moves the workpiece 66 in one direction as indicated by an arrow 96. The vision sensor 30 is supported by a support member 70. The vision sensor 30 is disposed so as to image the workpiece 66 from above the workpiece 66 that is conveyed by the conveyor 6. In this way, in the inspection device 8, the position and the orientation of the vision sensor 30 are fixed.

The controller 9 includes the arithmetic processing device 25 including a CPU as a processor. The arithmetic processing device 25 includes a processing unit obtained by excluding the command generation unit 58 from the processing unit 60 of the second robot apparatus 7 (see FIG. 14).

In addition, the arithmetic processing device 25 includes a conveyor control unit that controls the operation of the conveyor 6. The conveyor control unit is equivalent to a processor that is driven in accordance with an operation program generated in advance. The conveyor control unit stops driving the conveyor 6 when the workpiece 66 is placed at a predetermined position with respect to the imaging region 91 of the vision sensor 30. In this example, the vision sensor 30 images the surfaces 66a of a plurality of workpieces 66. The inspection device 8 inspects the plurality of workpieces 66 during operation at one time.

The position information generation unit 52 generates a distance image of each of the workpieces 66. The cutting line setting unit 53 sets a cutting line for each of the workpieces. Then, the cross-sectional image generation unit 54 generates cross-sectional images of the surfaces 66a of the respective workpieces 66. The processing unit can inspect the respective workpieces 66 based on the cross-sectional images.

As described above, the vision sensor of the processing device may be fixed. In addition, the processing device may perform image processing on a plurality of objects placed in the imaging region of the vision sensor at a time. For example, a plurality of workpieces may be inspected at a time. By performing this control, work efficiency is improved.

The vision sensor of the present embodiment is a stereo camera, but is not limited to this configuration. As the vision sensor, an area-scan type sensor that can acquire position information of a predetermined region of a surface of an object can be employed. In particular, a sensor that can acquire position information of a three-dimensional point set on a surface of an object in the imaging region of the vision sensor can be employed. For example, a time of flight (TOF) camera that acquires position information of a three-dimensional point based a flight time of light can be employed as the vision sensor. A device for detecting position information of a three-dimensional point includes a device that detects a position of a surface of an object by scanning a predetermined region with a laser range finder.

In each of the above-described control, the order of steps can be changed appropriately to the extent that the function and the effect are not changed.

The above-described embodiments can be suitably combined. In each of the above drawings, the same or similar parts are denoted by the same reference numerals. It should be noted that the above-described embodiments are examples and do not limit the invention. Further, the embodiments include modifications of the embodiments described in the claims.

### REFERENCE SIGNS LIST

1 robot
2, 9 controller
3, 7 robot apparatus
8 inspection device
24, 25 arithmetic processing device
vision sensor
41 operation program
42 storage
43 operation control unit
49 teach pendant
49a input part
49b display
51, 60 processing unit
52 position information generation unit
53 cutting line setting unit
54 cross-sectional image generation unit
55 coordinate system conversion unit
57 feature detection unit
65, 66 workpiece
65a, 66a surface
65c feature portion
71 robot coordinate system
73 sensor coordinate system
81, 83 distance image
82c, 84c cutting line
85 three-dimensional point
86, 87, 88, 89 cross-sectional image
90 reference cross-sectional image
91 imaging region

1. A processing device comprising:
a vision sensor configured to acquire information on a surface of an object placed in an imaging region;
a position information generation unit configured to generate position information of the surface of the object in three dimensions based on the information on the surface of the object;
a cutting line setting unit configured to set a cutting line for acquiring a cross-sectional image of the surface of the object by manipulating the position information of the surface of the object; and
a cross-sectional image generation unit configured to create a cross-sectional image in two dimensions, the cross-sectional image being obtained by cutting the surface of the object based on the position information of the surface of the object corresponding to the cutting line set by the cutting line setting unit.

2. The processing device of claim 1, further comprising,
a display configured to display the position information of the surface of the object, and
an input part configured to manipulate an image displayed on the display by an operator, wherein
the cutting line setting unit sets a line specified by an operator with respect to the position information of the surface of the object displayed on the display as the cutting line.

3. The processing device of claim 1, wherein
the processing device is disposed at a robot apparatus including a robot configured to change a position and an orientation of the vision sensor,
a robot coordinate system and a sensor coordinate system are set for the robot apparatus, the robot coordinate system being immovable when a position and an orientation of the robot are changed, and a position and an orientation of the sensor coordinate system being changed together with the vision sensor,
the processing device further includes a coordinate system conversion unit configured to convert the position information of the surface of the object acquired in the sensor coordinate system into the position information of the surface of the object represented in the robot coordinate system, and
the cross-sectional image generation unit generates a cross-sectional image represented in the robot coordinate system based on the position information of the surface of the object represented in the robot coordinate system.

4. The processing device of claim 1, wherein image processing is performed on the cross-sectional image generated by the cross-sectional image generation unit.

5. The processing device of claim 4, further comprising a feature detection unit configured to detect a feature portion of the object, wherein
the feature detection unit detects the feature portion of the object by performing a matching between a reference cross-sectional image created in advance and the cross-sectional image generated by the cross-sectional image generation unit.

6. The processing device of claim 5, further comprising a storage configured to store information on an output of the vision sensor, wherein
the vision sensor images an object serving as a reference for generating the reference cross-sectional image,
the position information generation unit generates position information of a surface of the object serving as a reference,
the cross-sectional image generation unit generates a cross-sectional image of the surface of the object serving as a reference, and
the storage stores the cross-sectional image of the object serving as a reference generated by the cross-sectional image generation unit as the reference cross-sectional image in performing the matching.

7. The processing device of claim 1, wherein the position information of the surface of the object is a distance image or a three-dimensional map.

8. A processing method comprising:
imaging an object by a vision sensor configured to acquire information on a surface of the object placed in an image capturing region;
generating position information of the surface of the object in three dimensions by a position information generation unit based on the information on the surface of the object;
setting a cutting line by a cutting line setting unit for acquiring a cross-sectional image of the surface of the object by manipulating the position information of the surface of the object; and
creating a cross-sectional image in two dimensions by a cross-sectional image generation unit, the cross-sectional image being obtained by cutting the surface of the object based on the position information of the surface of the object corresponding to the cutting line set by the cutting line setting unit.
